(19) United States
(12) Patent Application Publication
(10) Pub. No.: US 2026/0006136 A1
(43) Pub. Date: Jan. 1, 2026

(54) NON-TRANSITORY COMPUTER-READABLE RECORDING MEDIUM STORING SET OF COMPUTER PROGRAMS FOR TERMINAL DEVICE, NON-TRANSITORY COMPUTER-READABLE RECORDING MEDIUM STORING FIRST COMPUTER PROGRAM FOR TERMINAL DEVICE, AND NON-TRANSITORY COMPUTER-READABLE RECORDING MEDIUM STORING SECOND COMPUTER PROGRAM FOR TERMINAL DEVICE

(71) Applicant: BROTHER KOGYO KABUSHIKI KAISHA, Nagoya (JP)

(72) Inventor: Kenju NARITA, Nagoya (JP)

(21) Appl. No.: 19/249,327

(22) Filed: Jun. 25, 2025

(30) Foreign Application Priority Data
Jun. 27, 2024 (JP) 2024-104049

(51) Int. Cl. H04N 1/00

(52) U.S. Cl. CPC H04N 1/0048; H04N 1/00464

(57) ABSTRACT

A terminal device may, according to a first computer program, display a first predetermined screen including service related information a display of the terminal device and, in a case where a first predetermined operation is received on the first predetermined screen, provide a display instruction to the second computer program. The terminal device may, according to the second computer program, in a case where the display instruction is received from the first computer program, display the service screen on the display.

### REFERENCE TO RELATED APPLICATION

This application claims priority to Japanese Patent Application No. 2024-104049 filed on Jun. 27, 2024. The entire content of the priority application is incorporated herein by

### REFERENCE

### Background Art

A communication system including a terminal, a printer, a first server, and a second server is known. The terminal displays a color selection screen when receiving an operation on a server icon in a top screen under a state where information related to the printer is in its memory.

### SUMMARY

The disclosure herein provides a novel and useful technology for displaying a service screen on a display of a terminal device.

Disclosed herein is a non-transitory computer-readable recording medium storing a set of computer programs for a terminal device. The computer programs may include a first computer program and a second computer program. The first computer program, when executed by a processor of the terminal device, may cause the terminal device to display a first predetermined screen including service related information on a display of the terminal device, the service related information being related to a service for a printer communicable with the terminal device, the service being provided to a user of the printer via the internet; and in a case where a first predetermined operation is received on the first predetermined screen, provide a display instruction to the second computer program, the display instruction being for displaying a service screen related to the service on the display. The second computer program, when executed by the processor, may cause the terminal device to display the service screen on the display in a case where the display instruction is received from the first computer program.

Also disclosed herein is a non-transitory computer-readable recording medium storing a first computer program for a terminal device. The first computer program, when executed by a processor of the terminal device, may cause the terminal device to display a first predetermined screen including service related information on a display of the terminal device, the service related information being related to a service for a printer communicable with the terminal device, the service being provided to a user of the printer via the internet; and in a case where a first predetermined operation is received on the first predetermined screen, provide a display instruction to a second computer program for the terminal device, the display instruction being for displaying a service screen related to the service on the display.

Also disclosed herein is a non-transitory computer-readable recording medium storing a second computer program for a terminal device. The second computer program, when executed by a processor of the terminal device, may cause the terminal device to in a case where a display instruction for displaying a service screen related to a service on a display of the terminal device is received from a first computer program for the terminal device, display the service screen on the display, the service being for a printer communicable with the terminal device and provided to a user of the printer via the internet.

In the configurations above, the terminal device provides the display instruction to the second computer program according to the first computer program in response to receiving the first predetermined operation on the first predetermined screen. The terminal device displays the service screen according to the second computer program in response to the second computer program receiving the display instruction from the first computer program. Thus, the service screen can be displayed using the first and second computer programs.

Terminal devices implemented by the above set of programs and methods of controlling such terminal devices are also novel and useful. Terminal devices implemented by the above first computer program and methods of controlling such terminal devices are also novel and useful. Terminal devices implemented by the above second computer program and methods of controlling such terminal devices are also novel and useful. Communication systems comprising the above terminal devices and printers are also novel and useful.

### BRIEF DESCRIPTION OF DRAWINGS

FIG. 1 is a diagram illustrating a configuration of a communication system.

FIG. 2 is examples of tables.

FIG. 3 is an example of a series of screens displayed at a terminal device during a print process.

FIG. 4 is a flowchart of a first display process executed by a device monitoring app in the terminal device.

FIG. 5 is a flowchart of a monitor screen display process executed by the device monitoring app in the terminal device.

FIG. 6 is a flowchart of a second display process executed by a device control app in the terminal device.

FIG. 7 is a flowchart of a subscription service screen display process executed by the device control app in the terminal device.

FIG. 8 is an example of a series of screens displayed at the terminal device in Case A.

FIG. 9 is an example of a series of screens displayed at the terminal device in Case B.

FIG. 10 is an example of a series of screens displayed at the terminal device in Case C.

FIG. 11 is an example of a series of screens displayed at the terminal device in Case D.

FIG. 12 is an example of a series of screens displayed at the terminal device in Case E.

FIG. 13 is an example of a series of screens displayed at the terminal device in Case F.

FIG. 14 is an example of a series of screens displayed at the terminal device in Case G.

FIG. 15 is an example of a series of screens displayed at the terminal device in Case H and Case I.

FIG. 16 is an example of a series of screens displayed at the terminal device in Case J.

### DESCRIPTION

### Embodiment

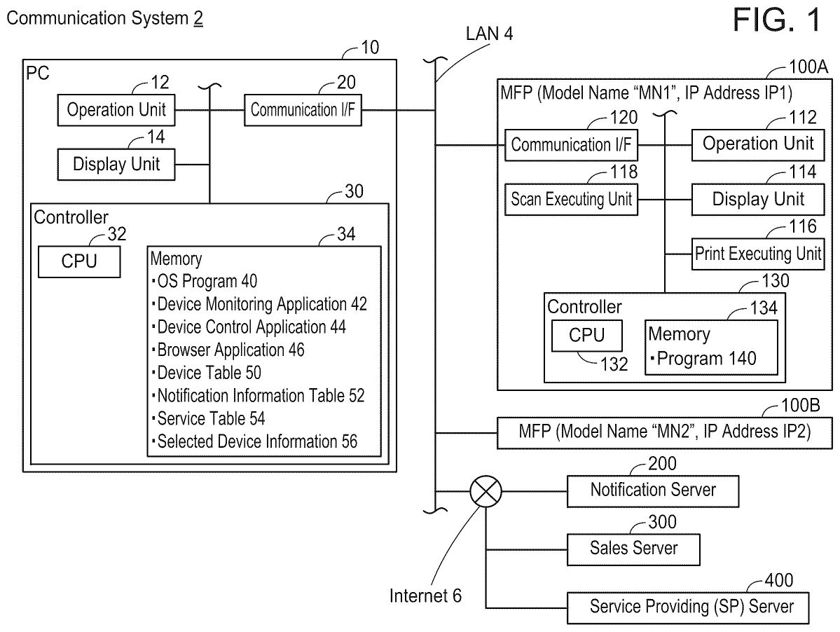

### (Configuration of Communication System 2: FIG. 1)

As shown in FIG. 1, a communication system 2 comprises a PC 10, MFPs 100A, 100B, a notification server 200, a sales server 300, and a service providing server 400. Hereinafter, the service providing server is abbreviated as “SP server”. The PC 10 and the MFPs 100A, 100B are connected to a local area network (LAN) 4. The PC 10 and the MFPs 100A, 100B are communicable with each other via the LAN 4. The LAN 4 is connected to the internet 6. The PC 10, the MFPs 100A, 100B, the notification server 200, the sales server 300, and the SP server 400 are connected to the internet 6. The devices are communicable with each other via the internet 6. The notification server 200, the sales server 300, and the SP server 400 may be individual servers separate from each other or may be integrated in a single server.

### (Configuration of PC 10)

The PC 10 is, for example, a desktop PC, a notebook PC, a tablet PC, or the like. The PC 10 comprises an operation unit 12, a display unit 14, a communication interface 20, and a controller 30. Hereinafter, an interface may be abbreviated as “I/F”.

The operation unit 12 is a user interface configured to allow a user to input various information to the PC 10. The operation unit 12 comprises, for example, a touch screen for displaying software keys (operation area), hardware keys, or both of these. The hardware keys include, for example, buttons, switches, or the like. The display unit 14 is a display or a panel for displaying various information. The display is, for example, a liquid crystal display or an organic EL display. The panel may be or may not be a touch panel. The panel may be, for example, a liquid crystal panel or an organic EL panel. The communication I/F 20 is connected to the LAN 4. The communication I/F 20 may be a wired I/F or a wireless I/F.

The controller 30 comprises a CPU 32 and a memory 34. The memory 34 comprises a main storage and an auxiliary storage. The main storage comprises a RAM and a cache memory, although this is merely an example. The auxiliary storage may comprise a ROM, a flash memory, a solid state drive (SSD), a hard disk drive (HDD), or any combination thereof, although this is merely an example. An operating system (OS) program 40, a device monitoring app 42, a device control app 44, and a browser app 46 are stored in the auxiliary storage of the memory 34. The device monitoring app 42 and the device control app 44 are provided as a single program. Hereinafter, the OS program 40 is abbreviated as “OS 40”. The OS 40 controls basic operations of the PC 10.

The device monitoring app 42 is a resident program. The resident program is automatically activated in response to the OS 40 being activated. The resident program is running background while the OS 40 is running. The device monitoring app 42 is a program for periodically acquiring status information from each MFP communicably connected to the PC 10 and displaying the acquired status information on the display unit 14 of the PC 10. The status information includes a remaining amount information, etc. The remaining amount information indicates remaining amounts in multiple color material cartridges mounted in the MFP. The multiple color material cartridges include color material cartridges for the following four colors: black (BK), cyan (C), magenta (M), and yellow (Y). The device monitoring app 42 is also a program for acquiring notification information from the notification server 200 and displaying a notification screen corresponding to the notification information on the display unit 14 in response to a notification condition being satisfied.

The device control app 44 is a non-resident program. The non-resident program is activated in response to receiving an activation operation from the user or receiving an activation instruction from the resident program. The device control app 44 is a program for causing an MFP to execute its print function, scan function, etc.

The browser app 46 is a program for accessing a web server to view web pages.

The CPU 32 executes various processes according to programs loaded from the main storage to the auxiliary storage. Hereinafter, various processes executed by the CPU 32 according to the programs may be described as if the OS 40, the device monitoring app 42, the device control app 44, or the browser app 46 execute these processes. The device monitoring app 42, the device control app 44, and the browser app 46 access relevant hardware, such as the display unit 14, the memory 34, the communication I/F 20, etc., via the OS 40 to execute the various processes. In the following description, “the device monitoring app 42, the device control app 44, and the browser app 46 execute the processes via the OS 40” is omitted when appropriate.

A device table 50, a notification information table 52, a service table 54, and selected device information 56 are also stored in the auxiliary storage of the memory 34. The selected device information 56 indicates device information of an MFP selected as the destination to which instruction information is sent from the device control app 44. The instruction information is a print instruction or a scan instruction. The device information includes the model name and IP address of the MFP.

### (Configurations of MFPs 100A, 100B)

The MFP 100A is a peripheral device (i.e., a peripheral device of the PC 10 or the like) configured to execute a print function of printing images on sheets and a scan function of reading printed images. The MFP 100A has a model name “MN1”. An IP address IP1 is assigned to the MFP 100A. The MFP 100A comprises an operation unit 112, a display unit 114, a print executing unit 116, a scan executing unit 118, and a communication I/F 120.

The operation unit 112 is an I/F configured to allow the user to input various information to the MFP 100A. The operation unit 112 comprises, for example, a touch screen for displaying software keys (operation objects), hardware keys, or both of these. The hardware keys include, for example, buttons, switches, or the like. The display unit 114 is a display or a panel for displaying various information. The display is, for example, a liquid crystal display or an organic EL display. The panel may be or may not be a touch panel. The panel may be, for example, a liquid crystal panel or an organic EL panel.

The print executing unit 116 comprises a print engine of inkjet scheme, electrophotographic scheme, or thermal scheme. A print engine of inkjet scheme comprises a print head configured to discharge drops of ink. A print engine of electrophotographic scheme comprises a photoreceptor, an exposure device configured to emit light to expose the photoreceptor to the light, and the like. A print engine of thermal scheme comprises a print head in which a heater emits heat. The scan executing unit 118 comprises a scan mechanism such as a CIS, CCD, or the like. The communication I/F 120 is connected to the LAN 4. The communication I/F 120 may be a wired I/F or a wireless I/F.

The controller 130 comprises a CPU 132 and a memory 134. The memory 134 comprises a main storage and an auxiliary storage. A program 140 is stored in the auxiliary storage of the memory 134. The CPU 132 executes various processes according to the program loaded from the auxiliary storage to the main storage.

The MFP 100B comprises the same configuration as that of the MFP 100A except that the MFP 100B has a model name “MN2” and an IP address IP2 is assigned to the MFP 100B.

### (Configuration of Notification Server 200)

The notification server 200 is established on the internet 6 by a vendor different from the vendor of the MFPs 100A, 100B (the latter vendor is simply termed “the vendor” hereinafter). The notification server 200 may be a single server or a collectivity of multiple servers.

The notification server 200 provides notification information. Each notification information is related to a device communicable with the PC 10. The notification server 200 sends notification information to the PC 10 in response to receiving a notification information request from the PC 10.

### (Configuration of Sales Server 300)

The sales server 300 is established on the internet 6 by the vendor. The sales server 300 may be a single server or a collectivity of multiple servers.

The sales server 300 is a server for selling color material cartridges for MFPs. The sales server 300 can support a consumable article purchasing service which is provided to the user via the internet 6. The consumable article purchasing service helps the user purchase color material cartridges.

### (Configuration of SP Server 400)

The SP server 400 is established on the internet 6 by the vendor. The SP server 400 may be a single server or a collectivity of multiple servers.

The SP server 400 provides a subscription service for MFPs via the internet 6. The subscription service charges a flat-rate fee when the number of printed sheets within a predetermined period (e.g., one month) is equal to or less than the contractual number of sheets (e.g., 1000 sheets), while it charges, when the number of printed sheets within the predetermined period exceeds the contractual number of sheets, a total of the flat-rate fee and an additional fee for the additional sheets exceeding the contractual number of sheets. The subscription service includes an automatic shipping service for consumable articles used in MFPs. In this embodiment, the consumable articles are color material cartridges. The automatic shipping service is a service of automatically shipping new consumable articles when remaining amounts in the currently used consumable articles become small.

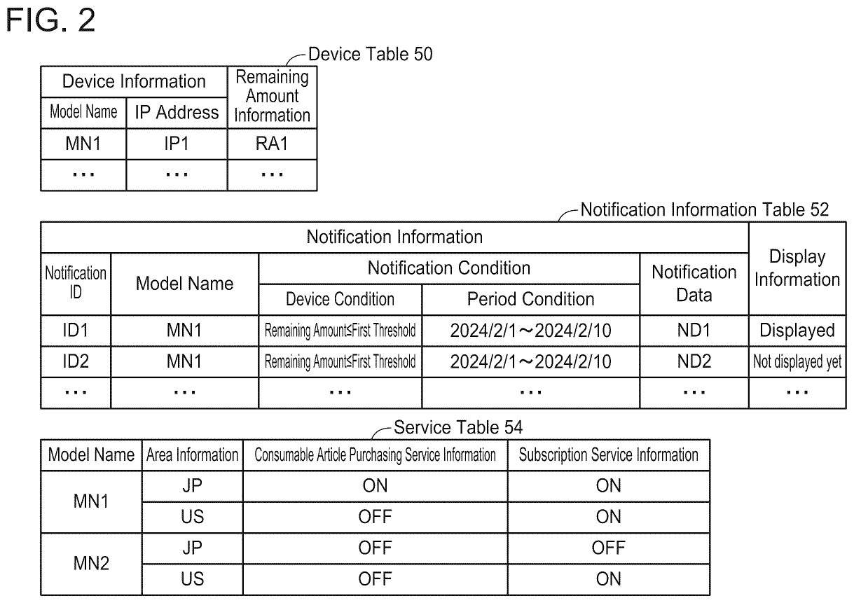

### (Device Table 50, Notification Information Table 52, Service Table 54: FIG. 2)

Referring to FIG. 2, the device table 50, the notification information table 52, and the service table 54 stored in the memory 34 of the PC 10 are described.

The device table 50 manages remaining amount information of MFPs that are communicably connected to the PC 10 and have been registered by the user in the device monitoring app 42 and the device control app 44. In the device table 50, each device information (i.e., a combination of a model name and an IP address) is associated with corresponding remaining information (e.g., RA1). The selected device information 56 in the memory 34 is one of one or more device information stored in the device table 50.

The notification information table 52 manages notification information received from the notification server 200. In the notification information table 52, each notification information is associated with corresponding display information. Each notification information includes a notification ID (e.g., ID1, ID2), a model name, a notification condition, and notification data (e.g., ND1, ND2). The notification ID is information for identifying the notification information. The model name indicates a model name of a target of the notification information. The notification condition indicates conditions based on which whether a notification screen corresponding to the notification information is to be displayed or not is determined. The notification condition includes a device condition and a period condition. The device condition is information indicating a device-related condition. The device condition may be “remaining amount≤first threshold”, although this is merely an example. The first threshold is “30”, although this is also merely an example. Alternatively, the device condition may be “not subscribed to the subscription service yet” or the like. The period condition is information indicating a period during which the notification screen is displayable. Each display information selectively indicates either “displayed”, which means that a notification related to the associated notification information has already been displayed, or “not displayed yet”, which means that the notification has not been displayed yet.

The service table 54 indicates areas where the consumable article purchasing service is supported. In the service table 54, each model name is associated with area information (e.g., JP, US), consumable article purchasing service information, and subscription service information. Each area information indicates a country. Each consumable article purchasing service information selectively indicates either “ON”, which means the consumable article purchasing service is supported, or “OFF”, which means that the consumable article purchasing service is not supported. Each subscription service information selectively indicates either “ON”, which means that the subscription service is supported, or “OFF”, which means that the subscription service is not supported. The device monitoring app 42, which is a resident program, displays a notification screen corresponding to the subscription service on the display unit 14 in a pop-up manner if it is determined that the model of a target of notification information supports the subscription service based on the information in the service table 54. In contrast, the device monitoring app 42 does not display the notification screen corresponding to the subscription service when it is determined that the model of a target of notification information does not support the subscription service. The device control app 44, which is a non-resident program, displays a subscribe button (which will be described later) on a home screen if it is determined that the model of device corresponding to the selected device information 56 supports the subscription service. In contrast, the device control app 44 does not display the subscribe button on the home screen if it is determined that the model of device does not support the subscription service.

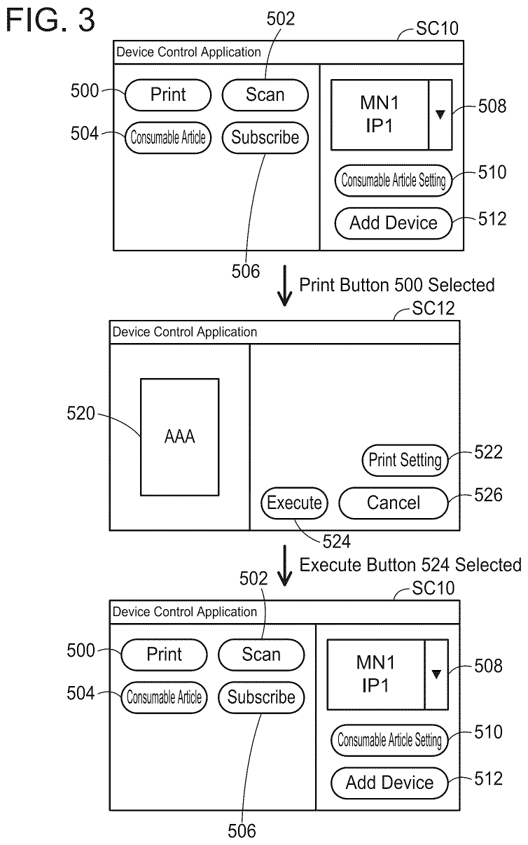

### (Print Process: FIG. 3)

Referring to FIG. 3, a print process is described. In the print process, the MFP 100A is caused to execute its print function by using the device control app 44. In the initial state of the print process shown in FIG. 3, device information “MN1, IP1” is stored as the selected device information 56 in the memory 34. In the drawings, in order to clarify which app, namely the app 42, 44, or 46, displays each screen, an app name is shown in an upper portion of each screen. Further, all communications between the PC 10 and the other devices (the MFP 100A, 100B and the servers 200, 300, 400) are executed via the communication I/F 20 of the PC 10. Thus, a phrase “via the communication I/F 20” is omitted in the following description.

The user performs an operation on the PC 10 to activate the device control app 44. In response, the PC 10 activates the device control app 44. The device control app 44 then specifies the device information “MN1, IP1” stored as the selected device information 56 and displays a home screen SC10 on the display unit 14. The home screen SC10 includes a print button 500, a scan button 502, a consumable article button 504, a subscribe button 506, a first device object 508, a consumable article setting button 510, and an add device button 512. The print button 500 is an object for execution of the print function. The scan button 502 is an object for execution of the scan function. The consumable article button 504 is a button for displaying a screen corresponding to the consumable article purchasing service. The subscribe button 506 is a button for displaying a screen corresponding to the subscription service. The first device object 508 shows the device information stored as the selected device information 56. The user can change the device information shown in the first device object 508 by performing an operation to the first device object 508. The selected device information 56 is thereby changed. The consumable article setting button 510 is a button for displaying a screen including remaining amount information of consumable articles. The add device button 512 is a button for registering an additional device in the device monitoring app 42 and the device control app 44.

The user performs an operation on the print button 500 in the home screen SC10. The user also performs an operation to select a file to be printed, although this is not illustrated. As a result, the device control app 44 displays a print preview screen SC12 on the display unit 14. The print preview screen SC12 includes a preview image 520 corresponding to the file to be printed, a print setting button 522, an execute button 524, and a cancel button 526. The print setting button 522 is a button for displaying a setting screen on which a print condition is changed. The execute button 524 is a button for sending a print instruction to the MFP. The print preview screen may include information for changing a print condition.

The user performs an operation on the execute button 524 in the print preview screen SC12. In response, the device control app 44 converts the file to be printed to print data and sends a print instruction including the print data and a print condition to the MFP 100A specified as the selected device information 56. The device control app 44 also displays the home screen SC10 on the display unit 14. The device control app 44 concurrently executes the process of sending the print instruction to the MFP 100A and the process of displaying the home screen SC10 on the display unit 14. The process of sending the print instruction to the MFP 100A may be still in progress after the home screen SC10 has been displayed. In response to receiving the print instruction from the PC 10, the MFP 100A executes its print function according to the print data and the print condition included in the print instruction. As above, the MFP 100A is caused to execute its print function by using the device control app 44.

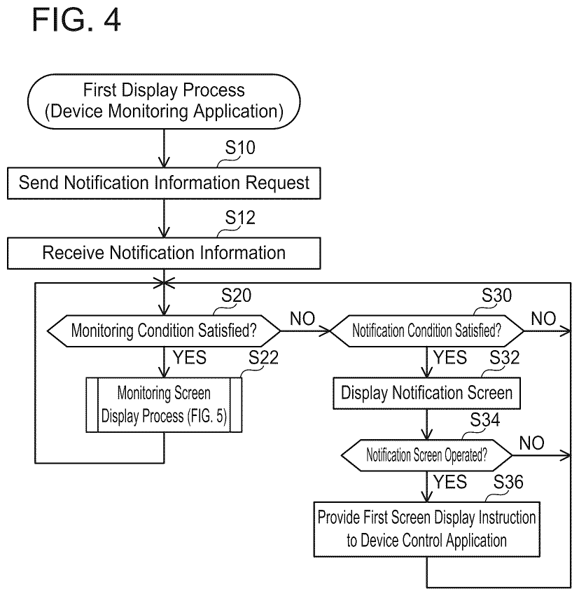

### (First Display Process: FIG. 4)

Referring to FIG. 4, a first display process executed by the device monitoring app 42 in the PC 10 is described. The device monitoring app 42 starts the process of FIG. 4 in response to being activated.

In S10, the device monitoring app 42 sends a notification information request to the server 200. In response to receiving the notification information request from the PC 10, the notification server 200 sends one or more notification information stored in the notification server 200 to the PC 10.

In S12, the device monitoring app 42 receives the one or more notification information from the notification server 200. The device monitoring app 42 specifies one or more notification information each including a model name in the device table 50 from among the received one or more notification information. Then, if the specified one or more notification information are not in the notification information table 52, the device monitoring app 42 stores the one or more notification information in the notification information table 52 in association with the display information “not displayed yet”.

In S20, the device monitoring app 42 monitors whether a monitor condition is satisfied based on the device table 50. The monitor condition is a condition for displaying a monitor screen, which will be described later. The monitor condition may be satisfied in response to one remaining amount included in all remaining amount information in the device table 50 being smaller than a second threshold, although this is merely an example. The second threshold is “20”, although this is merely an example. When the monitor condition is satisfied, the device monitoring app 42 makes a determination of YES in S20 and proceeds to S22.

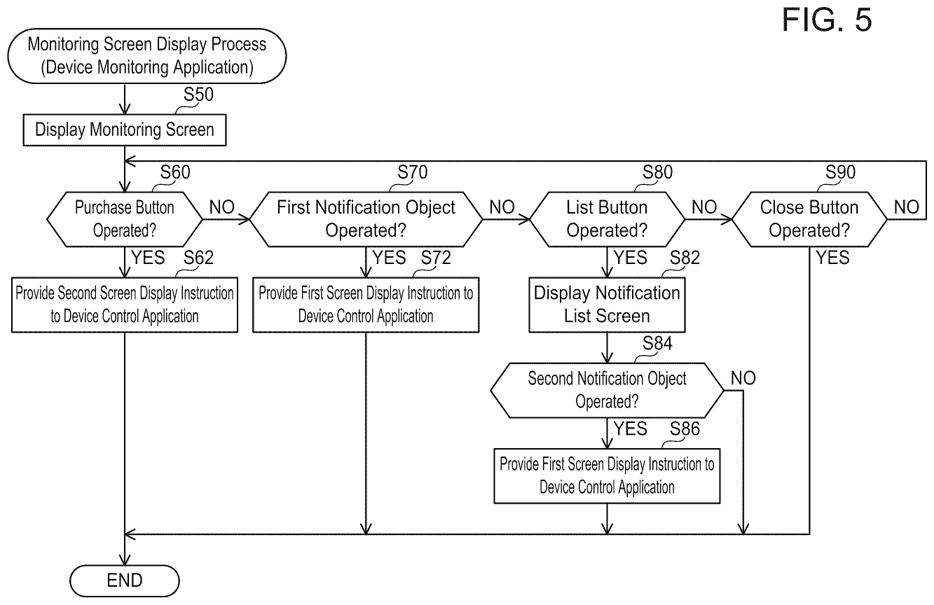

In S22, the device monitoring app 42 executes a monitor screen display process (see FIG. 5). This process is related to display of the monitor screen. When completing S22, the device monitoring app 42 returns to S20. In S20 after S22, the device monitoring app 42 makes a determination of YES in response to another remaining amount, which is different from the remaining amount that was used for the previous determination on whether the monitor condition is satisfied, being smaller than the second threshold.

Concurrently with the monitoring in S20, the device monitoring app 42 monitors in S30 whether any one of notification conditions associated with the display information “not displayed yet” in the notification information table 52 is satisfied. When any one of the notification conditions is satisfied, the device monitoring app 42 makes a determination of YES in S30 and proceeds to S32. Hereinafter, the notification information including the notification condition determined as being satisfied in S30 is termed target notification information.

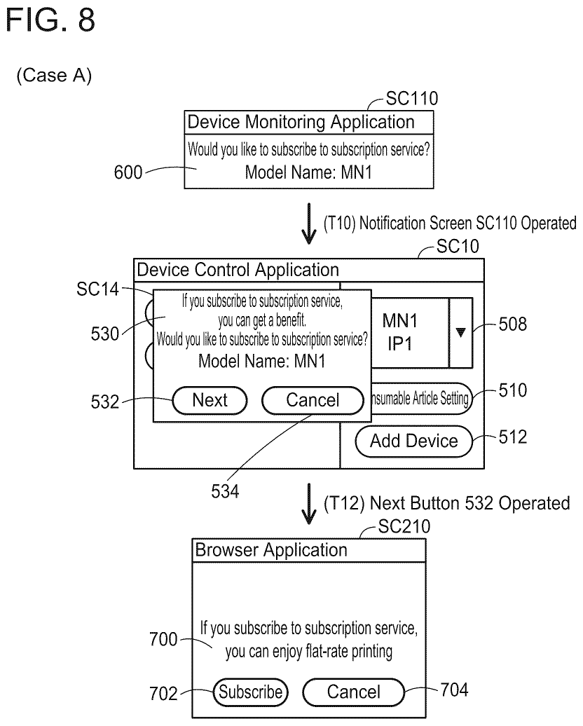

In S32, the device monitoring app 42 displays a notification screen in a pop-up manner on the display unit 14 by using the notification data included in the target notification information. As shown in FIG. 8, a notification screen SC110 includes a message 600 that prompts the user to subscribe to the subscription service and the model name included in the target notification information, although this is merely an example.

In S34 of FIG. 4, the device monitoring app 42 determines whether an operation is received on the notification screen (this operation is termed “notification screen operation”). When determining that the notification screen operation has been received (YES in S34), the device monitoring app 42 terminates the display of the notification screen and proceeds to S36. In this case, the device monitoring app 42 changes the display information associated with the target notification information in the notification information table 52 from “not displayed yet” to “displayed”. In contrast, when determining that a predetermined period has elapsed without the notification screen operation being received (NO in S34), the device monitoring app 42 terminates the display of the notification screen and returns to S20.

In S36, the device monitoring app 42 specifies from the device table 50 the device information that includes the model name included in the target notification information and provides a first screen display instruction including the specified device information and the target notification information to the device control app 44. The first screen display instruction is a signal for activating the device control app 44. The first screen display instruction is also a signal for instructing the device control app 44 to display a subscription service information screen. When completing S36, the device monitoring app 42 returns to S20. The first screen display instruction may include only a part of the target notification information, such as a notification ID, instead of the entire target notification information.

### (Monitor Screen Display Process: FIG. 5)

Referring to FIG. 5, the monitor screen display process executed in S22 of FIG. 4 is described.

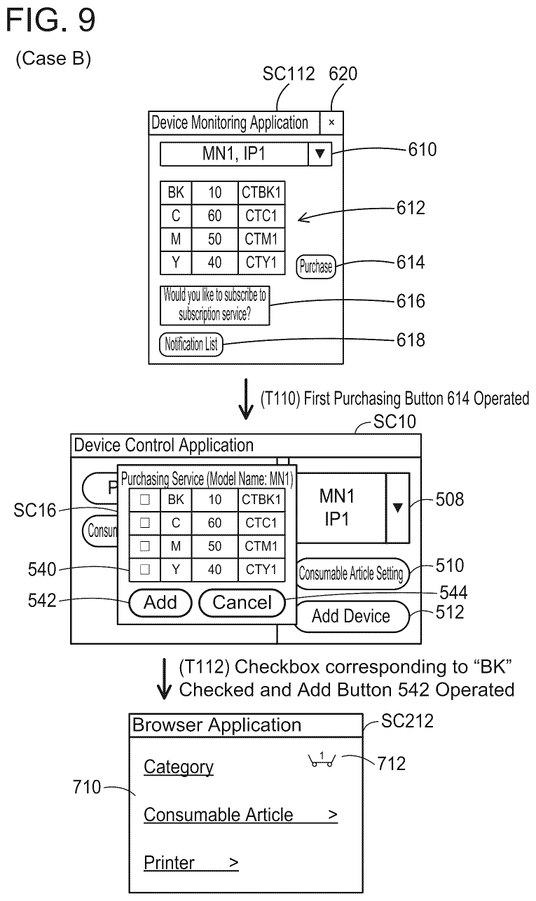

In S50, the device monitoring app 42 displays a monitor screen on the display unit 14. A monitor screen SC112 shown in FIG. 9 includes a second device object 610, a first remaining amount table 612, a first purchase button 614, a first notification object 616, a notification list button 618, and a close button 620, although this is merely an example. The monitor screen SC112 is displayed in response to the monitor condition having been satisfied for the MFP 100A. The second device object 610 shows the device information of the MFP for which the monitor condition has been satisfied. The user can change the device information shown in the second device object 610 by performing an operation on the second device object 610. The first remaining amount table 612 includes remaining amounts and model names of the color materials. The first purchase button 614 is a button for displaying a screen related to a first consumable article purchasing service. The first notification object 616 is information corresponding to the notification data. The first notification object is displayed only when there is notification information that is associated with the display information “not displayed yet” in the notification information table 52 and includes satisfied notification condition. The notification list button 618 is a button for displaying a notification list.

In S60 of FIG. 5, the device monitoring app 42 monitors whether an operation is received on the first purchase button in the monitor screen (this operation is termed “purchase button operation”). When the purchase button operation is received, the device monitoring app 42 makes a determination of YES in S60 and proceeds to S62.

In S62, the device monitoring app 42 provides a second screen display instruction including the device information corresponding to the monitor screen to the device control app 44. The second screen display instruction is a signal for activating the device control app 44. The second screen display instruction is also a signal for instructing the device control app 44 to display a first consumable article purchasing service screen. When completing S62, the device monitoring app 42 ends the process of FIG. 5.

Concurrently with the monitoring in S60, the device monitoring app 42 monitors in S70 whether an operation is received on the first notification object in the monitor screen (this operation is termed “first notification object operation”). When the first notification object operation is received, the device monitoring app 42 makes a determination of YES in S70 and proceeds to S72.

In S72, the device monitoring app 42 provides a first screen display instruction including the device information corresponding to the first notification object to the device control app 44. When completing S72, the device monitoring app 42 ends the process of FIG. 5.

Concurrently with the monitoring in S60 and the monitoring in S70, the device monitoring app 42 monitors in S80 whether an operation is received on the notification list button in the monitor screen (this operation is termed “list button operation”). When the list button operation is received, the device monitoring app 42 makes a determination of YES in S80 and proceeds to S82.

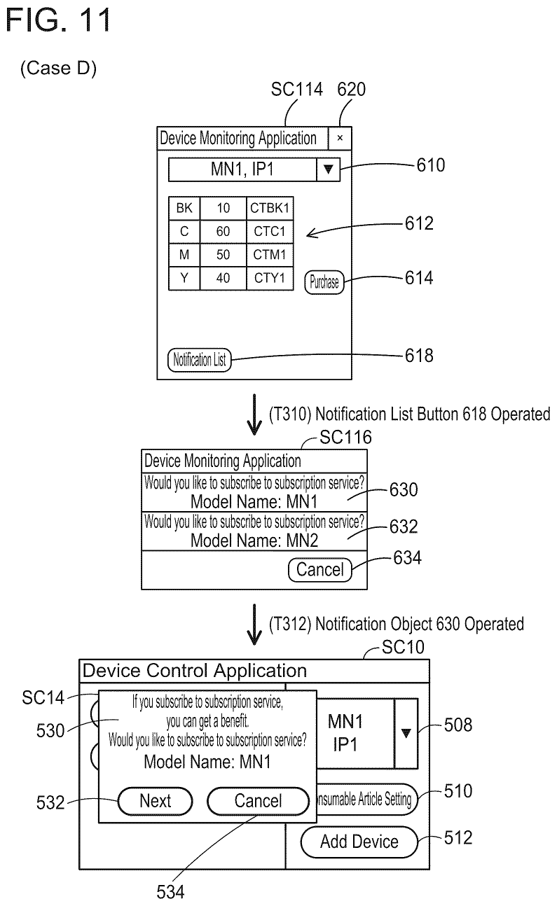

In S82, the device monitoring app 42 displays a notification list screen on the display unit 14 using the notification information table 52. The notification list screen includes one or more second notification objects corresponding to one or more notification information associated with the display information “displayed” in the notification information table 52. A notification list screen SC116 shown in FIG. 11 includes a plurality of second notification objects 630, 632 and a cancel button 634, although this is merely an example.

In S84 of FIG. 5, the device monitoring app 42 determines whether an operation is received on one of the one or more second notification objects in the notification list screen (this operation is termed “second notification object operation”). When the second notification object operation is received (YES in S84), the device monitoring app 42 proceeds to S86. In contrast, when an operation is received on the cancel button in the notification list screen (NO in S84), the device monitoring app 42 ends the process of FIG. 5.

In S86, the device monitoring app 42 provides a first screen display instruction including the device information corresponding to the second notification object to the device control app 44. When completing S86, the device monitoring app 42 ends the process of FIG. 5.

Concurrently with the monitoring in S60, the monitoring in S70, and the monitoring in S80, the device monitoring app 42 monitors in S90 whether an operation is received on the close button in the monitor screen (this operation is termed “close button operation”). When the close button operation is received, the device monitoring app 42 makes a determination of YES in S90 and ends the process of FIG. 5.

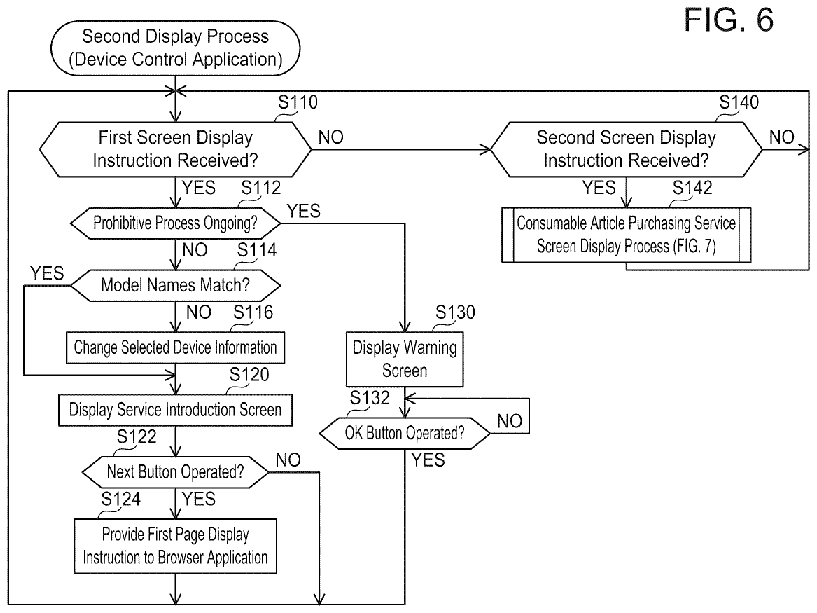

### (Second Display Process: FIG. 6)

Referring to FIG. 6, a second display process executed by the device control app 44 is described.

In S110, the device control app 44 determines whether the first screen display instruction has been received from the device monitoring app 42. When determining that the first screen display instruction has been received from the device monitoring app 42 (YES in S110), the device control app 44 proceeds to S112. The device control app 44 also makes a determination of YES in S110 when the device control app 44 is activated in response to receiving the first screen display instruction from the device monitoring app 42. In contrast, when determining that the first screen display instruction has not been received from the device monitoring app 42 (NO in S110), the device control app 44 proceeds to S140.

In S112, the device control app 44 determines whether the device control app 44 is executing a prohibitive process. The prohibitive process includes, but not limited to, a process of sending a print instruction to an MFP, a process of sending a scan instruction to an MFP, a process of displaying a print preview screen on the display unit 14, a process of displaying a print condition screen on the display unit 14, and a process of displaying a scan condition screen on the display unit 14. When determining that the device control app 44 is executing the prohibitive process (YES in S112), the device control app 44 proceeds to S130. In contrast, when determining that the device control app 44 is not executing the prohibitive process (NO in S112), the device control app 44 proceeds to S114.

In S114, the device control app 44 determines whether the model name included in the device information in the first screen display instruction matches the model name included in the selected device information 56 in the memory 34. When determining that the two model names match (YES in S114), the device control app 44 proceeds to S120. In contrast, when determining that the two model names do not match (NO in S114), the device control app 44 proceeds to S116. If two or more MFPs having the same model name are in the device table 50, the device control app 44 may use IP addresses instead of model names in S114.

In S116, the device control app 44 changes the selected device information 56 to the device information included in the first screen display instruction. In response, the device information shown in the first device object in the home screen is changed, if it is displayed on the display unit 14.

In S120, the device control app 44 displays a service introduction screen on the display unit 14. As shown in FIG. 8, a service introduction screen SC14 includes a message 530 that prompts the user to subscribe to the subscription service, a model name, a next button 532, and a cancel button 534, although this is merely an example. The service introduction screen includes the model name displayed in the notification screen or the model name shown in the first notification object in the monitor screen. That is, the service introduction screen is a screen for the MFP shown in the notification screen or in the first notification object in the monitor screen. As above, the user can display the screen for the MFP shown in the notification screen or in the first notification object in the monitor screen by performing an operation on the notification screen or the first notification object in the monitor screen at the PC 10.

In S122 of FIG. 6, the device control app 44 determines whether an operation has been received on the next button in the service introduction screen (this operation is termed “next button operation” hereinafter). When determining that the next button operation has been received (YES in S122), the device control app 44 proceeds to S124. In contrast, when determining that an operation has been received on the cancel button in the service introduction screen (NO in S122), the device control app 44 terminates the display of the service introduction screen and returns to S110.

In S124, the device control app 44 provides a first page display instruction to the browser app 46. The first page display instruction is a signal for causing the browser app 46 to display a web page corresponding to the subscription service. The first page display instruction includes device information. When completing S124, the device control app 44 returns to S110.

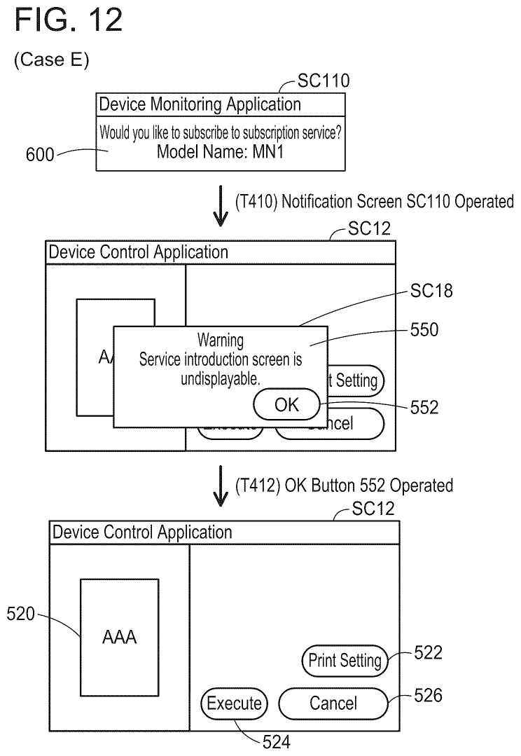

After making a determination of YES in S112, the device control app 44 displays a warning screen on the display unit 14 in S130. As shown in FIG. 12, a warning screen SC18 includes a message 550 indicating that the service introduction screen is undisplayable and an OK button 552, although this is merely an example.

In S132 of FIG. 6, the device control app 44 monitors whether an operation is received on the OK button in the warning screen (this operation is termed “OK button operation”). When the OK button operation is received, the device control app 44 makes a determination of YES in S132, terminates the display of the warning screen, and returns to S110. The device control app 44 also changes the display information associated with the target notification information in the notification information table 52 from “displayed” to “not displayed yet”

After making a determination of NO in S110, the device control app 44 determines in S140 whether the second screen display instruction has been received from the device monitoring app 42. When determining that the second screen display instruction has been received from the device monitoring app 42 (YES in S140), the device control app 44 proceeds to S142. The device control app 44 also makes a determination of YES in S140 when the device control app 44 is activated in response to receiving the second screen display instruction from the device monitoring app 42. In contrast, when determining that the second screen display instruction has not been received from the device monitoring app 42 (NO in S140), the device control app 44 returns to S110.

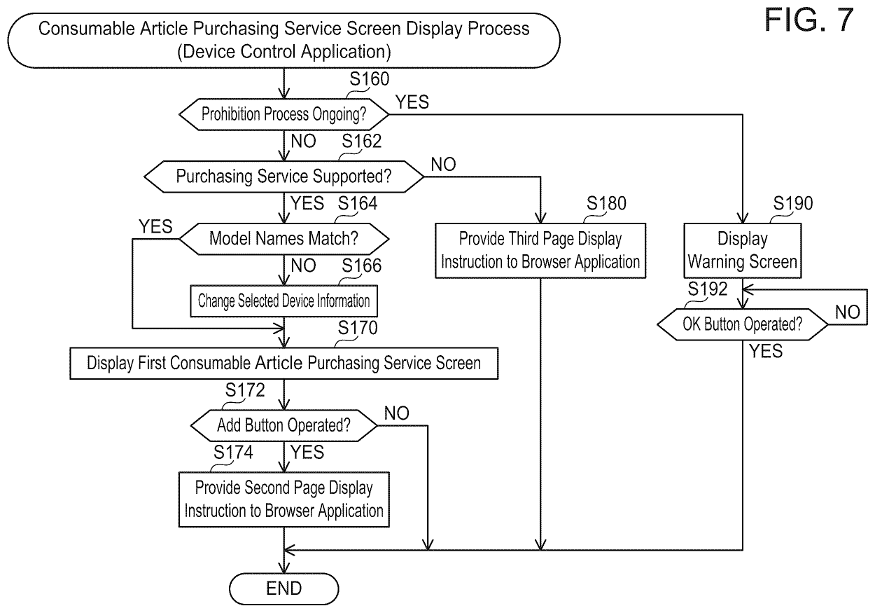

In S142, the device control app 44 executes a consumable article purchasing service screen display process (see FIG. 7). The consumable article purchasing service screen display process is a process for displaying a screen related to the consumable article purchasing service. When completing S142, the device control app 44 returns to S110.

### (Consumable Article Purchasing Service Screen Display Process: FIG. 7)

Referring to FIG. 7, the consumable article purchasing service screen display process executed in S142 of FIG. 6 is described.

S160 is the same as S112 in FIG. 6. When making a determination of YES in S160, the device control app 44 proceeds to S162, whereas when making a determination of NO in S160, the device control app 44 proceeds to S190. S190 and S192 are the same as S130 and S132 in FIG. 6, respectively. When making a determination of YES in S192, the device control app 44 ends the process of FIG. 7.

In S162, the device control app 44 determines whether the sales server 300 supports the consumable article purchasing service based on the device information included in the second screen display instruction and the service table 54 in the memory 34. The device control app 44 specifies the model name included in the device information in the second screen display instruction and also specifies a usage area. In this embodiment, the usage area is “Japan”. The device control app 44 determines whether the consumable article purchasing service information associated with the specified model name and usage area information in the service table 54 indicates “ON”. When the consumable article purchasing service information indicates “ON”, the device control app 44 makes a determination of YES in S162 and proceeds to S164. In contrast, when the consumable article purchasing service information indicates “OFF”, the device control app 44 makes a determination of NO in S162 and proceeds to S180. The determination in S162 can be rephrased as a determination on whether the usage area is an area where the consumable article purchasing service is supported.

S164 and S166 are the same as S114 and S116 in FIG. 6, respectively, except that the device information included in the second screen display instruction is used.

In S170, the device control app 44 displays a first consumable article purchasing service screen on the display unit 14. As shown in FIG. 9, a first consumable article purchasing service screen SC16 includes the model name, a second remaining amount table 540, an add button 542, and a cancel button 544, although this is merely an example. The second remaining amount table 540 includes remaining amounts of the color materials, the model name, and checkboxes for the color material cartridges.

In S172 of FIG. 7, the device control app 44 determines whether an operation has been received on the add button in the first consumable article purchasing service screen. When determining that an operation has been received on the add button (YES in S172), the device control app 44 proceeds to S174. In contrast, when determining that an operation has been received on the cancel button (NO in S172), the device control app 44 terminates the display of the first consumable article purchasing service screen and ends the process of FIG. 7.

In S174, the device control app 44 provides a second page display instruction to the browser app 46. The second page display instruction is a signal for causing the browser app 46 to display a web page of the sales server 300 for the consumable article purchasing service. The second page display instruction includes the model name and type information indicating one or more color material cartridges for which the checkbox(es) were marked in the first consumable article purchasing service screen. When completing S174, the device control app 44 ends the process of FIG. 7.

After making a determination of NO in S162, the device control app 44 provides a third page display instruction to the browser app 46 in S180. The third page display instruction is an instruction for causing the browser app 46 to display a web page of the sales server 300 that is not for the consumable article purchasing service. When completing S180, the device control app 44 ends the process of FIG. 7.

### (Specific Cases: FIGS. 8 to 16)

Referring to FIGS. 8 to 16, specific cases realized by the communication system 2 according to this embodiment is described.

### (Case A: FIG. 8)

Referring to FIG. 8, Case A is described. In the initial state of Case A, the notification screen SC110 is being displayed on the display unit 14 (S32) in response to a notification condition for the model name “MN1” having been satisfied (YES in S30 of FIG. 4). Further, in the initial state, the device information “MN1, IP1” is stored as the selected device information 56 in the memory 34 of the PC 10 and the device control app 44 is displaying the home screen SC10.

In T10, the user performs an operation on the notification screen SC110. In response, the device monitoring app 42 determines that the notification screen operation has been received (YES in S34) and provides a first screen display instruction including the device information “MN1, IP1” to the device control app 44 (S36). The device monitoring app 42 also changes the display information corresponding to the notification screen SC110 from “not displayed yet” to “displayed” in the notification information table 52.

The device control app 44 determines that the first screen display instruction has been received from the device monitoring app 42 (YES in S110 of FIG. 6) and then determines that it is not executing the prohibitive process since the home screen SC10 is being displayed (NO in S112). The device control app 44 also determines that the model name “MN1” included in the first screen display instruction matches the model name “MN1” included in the selected device information 56 (YES in S114). In this case, the device control app 44 displays the service introduction screen SC14 over the home screen SC10 without changing the selected device information 56 (S120).

In T12, the user performs an operation on the next button 532 in the service introduction screen SC14 at the PC 10. In response, the device control app 44 determines that the next button operation has been received (YES in S122) and then provides a first page display instruction to the browser app 46 (S124).

In response to receiving the first page display instruction from the device control app 44, the browser app 46 sends a first page request to the SP server 400. The first page request is a signal that requests service information page data indicating a service information page to be sent. In response to receiving the service information page data from the SP server 400, the browser app 46 displays a service information page SC210 on the display unit 14. The service information page SC210 includes an information message 700, a subscribe button 702, and a cancel button 704. The information message 700 says “If you subscribe to the subscription service, you can enjoy flat-rate printing”, although this is merely an example. When the user performs an operation on the subscribe button 702, a subscription process is started between the PC10, the MFP 100A, and the SP server 400.

### (Case B: FIG. 9)

Referring to FIG. 9, Case B is described. In the initial state of Case B, the monitor screen SC112 is being displayed on the display unit 14 (S50 in FIG. 5) in response to a monitor condition for the MFP 100A having been satisfied (YES in S20 of FIG. 4). Except for this, the initial state of Case B is the same as that of Case A shown in FIG. 8.

In T110, the user performs an operation on the first purchase button 614 in the monitor screen SC112. In response, the device monitoring app 42 determines that the purchase button operation has been received (YES in S60) and then provides a second screen display instruction including the device information “MN1, IP1” to the device control app 44 (S62).

The device control app 44 determines that the second screen display instruction has been received from the device monitoring app 42 (YES in S140 of FIG. 6) and also determines that it is not executing the prohibitive process (NO in S160). Further, the device control app 44 determines that the sales server 300 supports the consumable article purchasing service (YES in S162) because the consumable article purchasing service information “ON” is associated with the area information “JP” indicating the usage area “Japan” where the PC 10 is used and the model name “MN1” included in the second screen display instruction in the service table 54. The device control app 44 also determines that the model name “MN1” included in the second screen display instruction matches the model name “MN1” included in the selected device information 56 (YES in S164). In this case, the device control app 44 displays the first consumable article purchasing service screen SC16 over the home screen SC10 without changing the selected device information 56 (S170).

In T112, the user marks the checkbox for the color material cartridge “BK” and performs an operation on the add button 542 in the first consumable article purchasing service screen SC16 at the PC 10. In response, the device control app 44 determines that the add button operation has been performed (YES in S172) and then provides a second page display instruction to the browser app 46 (S174). The second page display instruction includes the model name “MN1” of the MFP 100A and type information indicating the color material cartridge “BK” for which the checkbox was marked in the first consumable article purchasing service screen SC16.

In response to receiving the second page display instruction from the device control app 44, the browser app 46 sends a second page request to the sales server 300. The second page request is a signal that requests first purchase page data indicating a first purchase page to be sent. The second page request includes the model name “MN1” and the type information “BK”. In response to receiving the first purchase page data from the sales server 300, the browser app 46 displays a first purchase page SC212 on the display unit 14. The first purchase page SC212 includes a selection object 710 and a basket (cart) 712. The selection object 710 is an object for selecting a category of items to be purchased. The basket 712 includes information indicating the number of items to be purchased. In the present case, the color material cartridge to be purchased is already selected, and thus the basket 712 indicates “1”. The user can select the basket 712 at the PC 10 to purchase the color material cartridge “BK”.

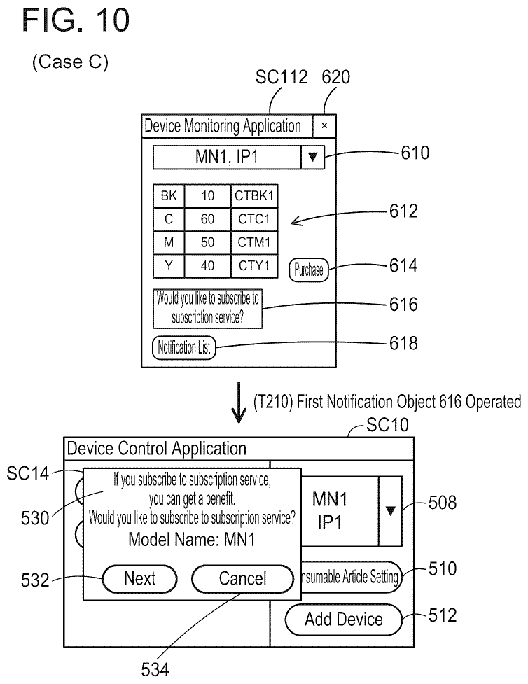

### (Case C: FIG. 10)

Referring to FIG. 10, Case C is described. The initial state of Case C is the same as that of Case B in FIG. 9.

In T210, the user performs an operation on the first notification object 616 in the monitor screen SC112. In response, the device monitoring app 42 determines that the first notification object operation has been received (YES in S70 of FIG. 5) and then provides a first screen display instruction including the device information “MN1, IP1” to the device control app 44 (S72). The device monitoring app 42 also changes the display information corresponding to the first notification object 616 from “not displayed yet” to “displayed” in the notification information table 52.

The device control app 44 executes the same process as that of Case A to display the service introduction screen SC14 over the home screen SC10 (S120 in FIG. 6). Thus, the user can also display the service introduction screen SC14 at the PC 10 by performing an operation on the first notification object 616 in the monitor screen SC112.

### (Case D: FIG. 11)

Referring to FIG. 11, Case D is described. In the initial state of Case D, the monitor screen SC114 is being displayed on the display unit 14 in response to a monitor condition for the MFP 100A having been satisfied (YES in S20 of FIG. 4). This monitor screen SC114 is the same as the monitor screen SC114 shown in FIG. 9 except that the former does not include the first notification object 616. In the initial state, the device information “MN1, IP1” is stored as the selected device information 56 in the memory 34 of the PC 10, the device control app 44 is not activated yet, and the display information “displayed” is associated with each of notification information including a notification ID1 and notification information including a notification ID2 in the notification information table 52.

In T310, the user performs an operation on the notification list button 618 in the monitor screen SC114. In response, the device monitoring app 42 determines that the list button operation has been received (YES in S80 of FIG. 5). In this case, the device monitoring app 42 specifies that the display information “displayed” is associated with each of the notification information including the notification ID1 and the notification information including the notification ID2 in the notification information table 52. Then, the device monitoring app 42 displays on the display unit 14 the notification list screen SC116 including second notification objects 630 and 632 corresponding to the notification information including the notification ID1 and the notification information including the notification ID2, respectively (S82).

In T312, the user performs an operation on the second notification object 630 at the PC 10. In response, the device monitoring app 42 determines that the second notification object operation has been received (YES in S84) and then provides a first screen display instruction including the device information “MN1, IP1” to the device control app 44 (S86). In the present case, since the device control app 44 is not activated yet, the device control app 44 is activated in response to receiving the first screen display instruction. Then, the device control app 44 determines that the first screen display instruction has been received from the device monitoring app 42 (YES in S110 of FIG. 6) and also determines that it is not executing the prohibitive process (NO in S112). Further, the device control app 44 determines that the model name “MN1” included in the first screen display instruction matches the model name “MN1” included in the selected device information 56 (YES in S114). Then, the device control app 44 displays the home screen SC10 in which the first device object 508 shows the device information “MN1, IP1” on the display unit 14 and then displays the service introduction screen SC14 over the home screen SC10 (S120). Thus, the user can also display the service introduction screen SC14 at the PC 10 by performing an operation on a second notification object in the notification list screen SC116.

### (Case E: FIG. 12)

Referring to FIG. 12, Case E is described. The initial state of Case E is the same as that of Case A shown in FIG. 8 except that the device control app 44 is displaying the print preview screen SC12.

In T410, the user performs an operation on the notification screen SC110. In response, the device monitoring app 42 determines that the notification screen operation has been received (YES in S34 of FIG. 4) and then provides a first screen display instruction including the device information “MN1, IP1” to the device control app 44 (S36). The device monitoring app 42 also changes the display information corresponding to the notification screen SC110 from “not displayed yet” to “displayed” in the notification information table 52.

The device control app 44 determines that the first screen display instruction has been received from the device monitoring app 42 (YES in S110 of FIG. 6) and also determines that it is executing the prohibitive process since it is displaying the print preview screen SC12 (YES in S112). In this case, the device control app 44 displays the warning screen SC18 over the print preview screen SC12 without displaying the service introduction screen SC14 (S130). If the service introduction screen SC14 were displayed on the display unit 14 instead of the print preview screen SC12 without displaying the warning screen SC18, the user would need to perform an operation again to display the print preview screen SC12. The configuration above improves user convenience since the display of the print preview screen SC12 is not terminated.

In T412, the user performs an operation on the OK button 552 in the warning screen SC18 at the PC 10 (YES in S132). In response, the device control app 44 terminates the display of the warning screen SC18. The device control app 44 also changes the display information corresponding to the notification screen SC110 from “not displayed yet” to “displayed” in the notification information table 52. If the service introduction screen SC14 were displayed on the display unit 14 instead of the print preview screen SC12 after the operation has been performed on the OK button 552 in the warning screen SC18, the user would need to perform an operation again to display the print preview screen SC12. The above configuration allows the user to perform an operation on the print preview screen SC12, thereby improving user convenience.

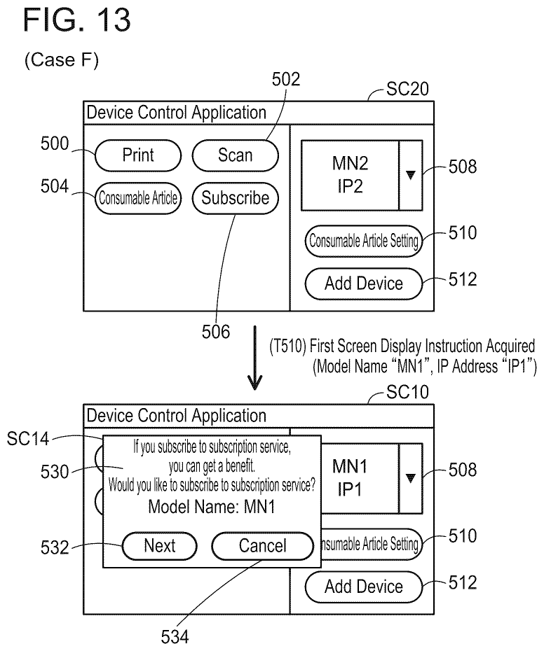

### (Case F: FIG. 13)

Referring to FIG. 13, Case F is described. In the initial state of Case F, device information “MN2, IP2” is stored as the selected device information 56 in the memory 34 of the PC 10. Further, in the initial state, the device control app 44 is displaying a home screen SC20 in which the device information “MN2, IP2” is shown in a first device object 508. In Case F, the device control app 44 receives a first screen display instruction including the device information “MN1, IP1” from the device monitoring app 42 while the home screen SC20 is being displayed.

In T510, the device control app 44 receives a first screen display instruction including the device information “MN1, IP1” from the device monitoring app 42. In response, the device control app 44 determines that the first screen display instruction has been received from the device monitoring app 42 (YES in S110 of FIG. 6) and also determines that it is not executing the prohibitive process since it is displaying the home screen SC20 (NO in S112). Further, the device control app 44 determines that the model name “MN1” included in the first screen display instruction does not match the model name “MN2” in the selected device information 56 (NO in S114). In this case, the device control app 44 changes the selected device information 56 from “MN2, IP2” to “MN1, IP1” and also changes the device information shown in the first device object 508 in the home screen SC20 from “MN2, IP2” to “MN1, IP1”. As a result, the home screen SC20 is changed to the home screen SC10. Then, the device control app 44 displays the service introduction screen SC14 over the home screen SC10 (S120). As described, the selected device information 56 is changed from “MN2, IP2” to “MN1, IP1”. Thus, the user can perform an operation on the home screen SC10 to use a function of the MFP 100A, for example, after the display of the service introduction screen SC14 is terminated, thereby improving user convenience.

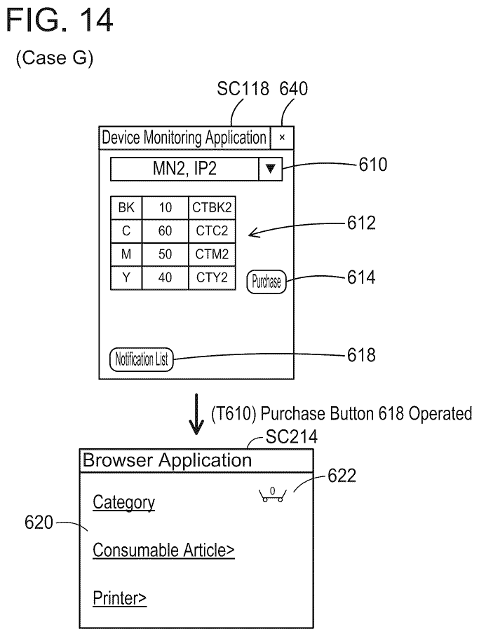

### (Case G: FIG. 14)

Referring to FIG. 14, Case G is described. In the initial state of Case G, a monitor screen SC118 for the MFP 100B is being displayed on the display unit 14 in response to a monitor condition for the MFP 100B having been satisfied (YES in S20 of FIG. 4). In the initial state, the consumable article purchasing service information “OFF” is associated with the model name “MN2” and the area information “JP” in the service table 54. Except for these, the initial state of Case G is the same as that of Case A shown in FIG. 9.

In T610, the user performs an operation on a first purchase button 614 in the monitor screen SC118 at the PC10. In response, the device monitoring app 42 determines that the purchase button operation has been received (YES in S60 of FIG. 5) and then provides a second screen display instruction including the device information “MN2, IP2” to the device control app 44 (S62).

The device control app 44 determines that the second screen display instruction has been received from the device monitoring app 42 (YES in S140 of FIG. 6) and also determines that it is not executing the prohibitive process (NO in S160). Further, the device control app 44 determines that the sales server 300 does not support the consumable article purchasing service (NO in S162) since the consumable article purchasing service information “OFF” is associated with the area information “JP” and the model name “MN2” included in the second screen display instruction in the service table 54 (NO in S162). In this case, the device control app 44 provides a third page display instruction to the browser app 46 (S180).

In response to receiving the third page display instruction from the device control app 44, the browser app 46 sends a third page request to the sales server 300. The third page request is a signal that requests second purchase page data indicating a second purchase page SC214 to be sent. The third page request does not include a model name nor type information. In response to receiving the second purchase page data from the sales server 300, the browser app 46 displays the second purchase page SC214 on the display unit 14. The second purchase page SC214 includes a selection object 620 and a basket 622. The basket 622 indicates “0 (zero)” meaning that a color material cartridge to be purchased is not selected yet. Thus, the user needs to perform an operation on the second purchase page SC214 to select a color material cartridge to be purchased.

As described, when determining that the sales server 300 does not support the consumable article purchasing service, the device control app 44 provides the third page display instruction to the browser app 46. Here, an alternative situation is conceivable where the first consumable article purchasing service screen is displayed on the display unit 14 under the state where the sales server 300 does not support the consumable article purchasing service and the user performs an operation on the first consumable article purchasing service screen. In this case, the browser app 46 sends the second page request to the sales server 300 in response to receiving the second page display instruction from the device control app 44. However, since the sales server 300 does not support the consumable article purchasing service, the browser app 46 receives an error notification or the second purchase page data from the sales server 300. Thus, the user's operation on the first consumable article purchasing service screen ends up in vain in this alternative example. In contrast, the above configuration prevents the user's operation from ending up in vain.

Further, the device control app 44 provides the third page display instruction to the browser app 46 when determining that the usage area is not Japan. This configuration also prevents user's operation from ending up in vain.

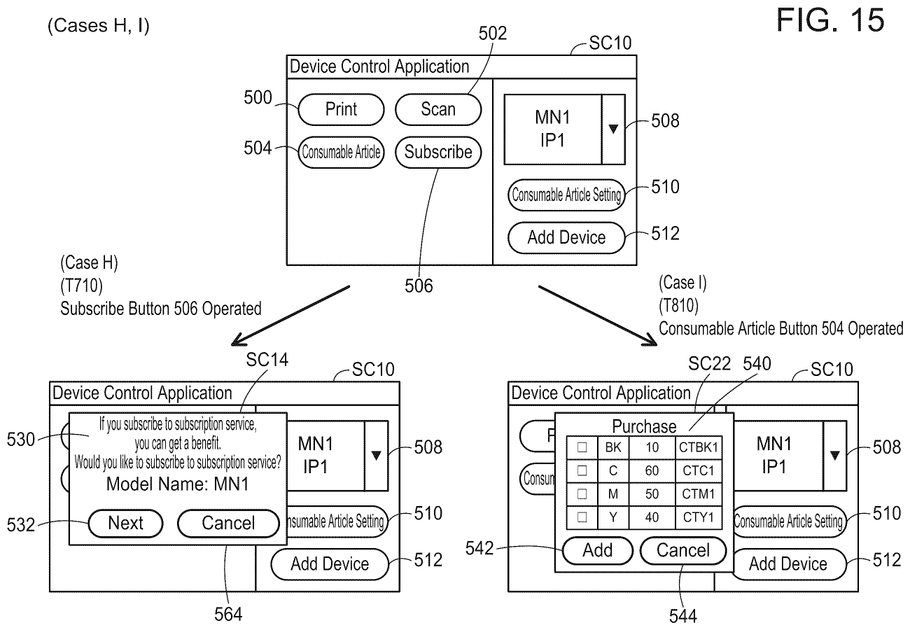

### (Case H: FIG. 15)

Referring to FIG. 15, Case His described. In the initial state of Case H, the device control app 44 is displaying the home screen SC10.

In T710, the user performs an operation on the subscribe button 506 in the home screen SC10. In response, the device control app 44 displays the service introduction screen SC14 corresponding to the device information “MN1, IP1” shown in the first device object 508 over the home screen SC10. Thus, the user can also display the service introduction screen SC14 at the PC 10 by performing an operation on the subscribe button 506 in the home screen SC10. That is, the device control app 44 can display the service introduction screen SC14 on the display unit 14 without receiving the first screen display instruction from the device monitoring app 42.

### (Case I: FIG. 15)

Referring to FIG. 15, Case I is described. The initial state of Case I is the same as that of Case H.

In T810, the user performs an operation on the consumable article button 504 in the home screen SC10. In response, the device control app 44 displays a second consumable article purchasing service screen SC22 corresponding to the device information “MN1, IP1” shown in the first device object 508 over the home screen SC10. The second consumable article purchasing service screen SC22 is the same as the first consumable article purchasing service screen SC16 (see FIG. 9) except that the former does not include a model name. The user can perform an operation on the add button 542 in the second consumable article purchasing service screen SC22 to enjoy the consumable article purchasing service.

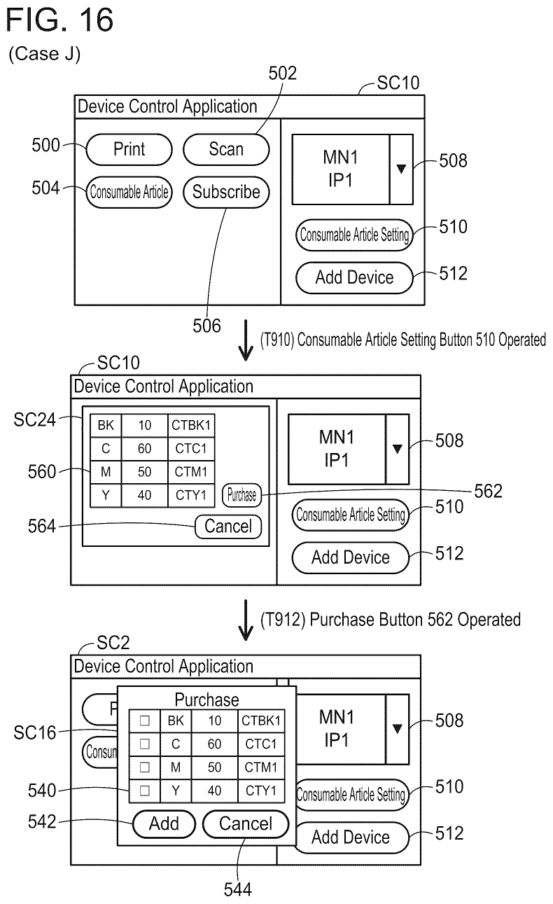

### (Case J: FIG. 16)

Referring to FIG. 16, Case J is described. The initial state of Case J is the same as that of Case H shown in FIG. 15.

In T910, the user performs an operation on the consumable article setting button 510 in the home screen SC10. In response, the device control app 44 displays a consumable article setting screen SC24 for the MFP 100A over the home screen SC10. The consumable article setting screen SC24 includes a third remaining amount table 560, a second purchase button 562, and a cancel button 564. The third remaining amount table 560 is the same as the first remaining amount table 612 shown in FIG. 9.

In T912, the user performs an operation on the second purchase button 562 in the consumable article setting screen SC24. In response, the device control app 44 displays the first consumable article purchasing service screen SC16 over the home screen SC10. Thus, the user can also display the first consumable article purchasing service screen SC16 at the PC 10 by performing an operation on the consumable article setting button 510 in the home screen SC10. That is, the device control app 44 can display the first consumable article purchasing service screen SC16 on the display unit 14 without receiving the second screen display instruction from the device monitoring app 42.

### Advantageous Effects of Embodiment

According to the above configuration, in the case where the notification screen operation is received on the notification screen SC110 (see FIG. 8) (YES in S34 of FIG. 4), the PC 10 provides the first screen display instruction to the device control app 44 according to the device monitoring app 42. In the case where the first screen display instruction is received from the device monitoring app 42 (YES in S110 of FIG. 6), the PC 10 displays the service introduction screen SC14 (see FIG. 8) according to the device control app 44 (S120). Thus, the service introduction screen SC14 can be displayed by using the device monitoring app 42 and the device control app 44.

In the case where the purchase button operation is received on the monitor screen SC112 (see FIG. 9) (YES in S60 of FIG. 5), the PC 10 provides the second screen display instruction to the device control app 44 according to the device monitoring app 42. In the case where the second screen display instruction is received from the device monitoring app 42 (YES in S140 of FIG. 6), the PC 10 displays the first consumable article purchasing service screen SC16 (see FIG. 9) according to the device control app 44 (S120). Thus, the first consumable article purchasing service screen SC16 can be displayed by using the device monitoring app 42 and the device control app 44.

Generally, where a resident program can display a screen on the display unit 14, the processing load on the PC 10 is increased regardless of whether the screen is being displayed on the display unit 14 or not. According to the configuration above, the service introduction screen SC14 and the first consumable article purchasing service screen SC16 are displayed on the display unit 14 by the device control app 44 which is a non-resident program, not by the device monitoring app 42 which is a resident program. This suppresses an increase in processing load of the PC 10.

### (Correspondence Relationships)

The device monitoring app 42 and the device control app 44 are an example of “a set of programs”. The device monitoring app 42 is an example of “first computer program”. The device control app 44 is an example of “second computer program”. The PC 10 is an example of “terminal device”. The MFPs 100A, 100B are examples of “printers”. The subscription service and the consumable article purchasing service are examples of “service”. The message 600 in the notification screen SC110 shown in FIG. 8 is an example of “service related information”. The first purchase button 614 in the monitor screen SC112 shown in FIG. 9 is an example of “service related information”. The notification screen SC110 shown in FIG. 8 and the monitor screen SC112 shown in FIG. 9 are examples of “first predetermined screen”. The notification screen operation, the purchase button operation, and the notification object operation are examples of “first predetermined operation”. The service introduction screen SC14 shown in FIG. 8 and the first consumable article purchasing service screen SC16 shown in FIG. 19 are examples of “service screen”. The first screen display instruction and the second screen display instruction are examples of “display instruction”. The MFP 100A is an example of “first printer”. The monitor condition and the notification condition are examples of “predetermined condition”. The model name “MN1” is an example of “first device identification information”. The MFP 100B is an example of “second printer”. The model name “MN2” is an example of “second device identification information”. The selected device information 56 is an example of “destination information”. The sales server 300 is an example of “server”. The second purchase page SC214 shown in FIG. 14 is an example of “web page”. Japan is an example of “predetermined area”. The subscribe button 506 in the home screen SC10 shown in FIG. 15 and the second purchase button 562 in the consumable article setting screen SC24 shown in FIG. 16 are examples of “object”. The home screen SC10 shown in FIG. 15 and the consumable article setting screen SC24 shown in FIG. 16 are examples of “second predetermined screen”. The prohibitive process is an example of “predetermined process”.

In an aspect, S32 in FIGS. 4 and S50 in FIG. 5 are examples of “display a first predetermined screen”. S36 in FIGS. 4 and S62 and S72 in FIG. 5 are examples of “provide a display instruction”. S120 in FIGS. 6 and S170 in FIG. 7 are examples of “display the service screen”.

In another aspect, S32 in FIGS. 4 and S50 in FIG. 5 are examples of “display a first predetermined screen” the first computer program causes the terminal device to do. S36 in FIGS. 4 and S62 and S72 in FIG. 5 are examples of “provide a display instruction”.

In another aspect, S120 in FIGS. 6 and S170 in FIG. 7 are examples of “display the service screen” the second computer program causes the terminal device to do.

It should be noted that “provide a display instruction to the second computer program” can be rephrased as providing a display instruction to a CPU operating according to the second computer program in order to use the display instruction in a process executed according to the second computer program.
(Modification 1) In the above embodiment, the device monitoring app 42 and the device control app 44 are provided as a single program. In a modification, the device monitoring app 42 and the device control app 44 may be provided as separate programs. In this modification, the device monitoring app 42 and the device control app 44 cooperate with each other to execute various processes after they have been installed in the PC 10.
(Modification 2) The “terminal device” is not limited to a PC and may be a mobile phone (e.g., a smartphone), a PDA, or the like.
(Modification 3) The “printer” is not limited to an MFP and may be a printing device having a print function out of scan and print functions, a large copying machine, or the like.
(Modification 4) The “service” is not limited to the consumable article purchasing service and the subscription service and may be an automatic shipping service or the like.
(Modification 5) The device monitoring app 42 and the device control app 44 may both be resident programs or non-resident programs. In another modification, the device monitoring app 42 may be a non-resident program and the device control app 44 may be a resident program.
(Modification 6) The service introduction screen SC14 shown in FIG. 8 and the first consumable article purchasing service screen SC16 shown in FIG. 9 may not include the model name of an MFP.
(Modification 7) The “device identification information” is not limited to a model name and may be the serial number, IP address, or MAC address of an MFP.
(Modification 8) S114 and S116 in FIGS. 6 and S164 and S166 in FIG. 7 may be omitted. That is, the device control app 44 may not change the selected device information 56 in the memory 34 in the case where the first or second screen display instruction is received from the device monitoring app 42. In this modification, “store the first device identification information” may be omitted.
(Modification 9) Instead of the browser app 46, the device control app 44 may display the service information page SC210, the first purchase page SC212, and the second purchase page SC214 on the display unit 14 using a web view function of the device control app 44.
(Modification 10) S112 in FIGS. 6 and S162 in FIG. 7 may be omitted. In this modification, “determine whether a server supports the service”, “in a case where it is determined that the server does not support the service, display on the display a web page”, “determine whether a usage area where the terminal device is used is a predetermined area”, and “in a case where it is determined that the usage area is not the predetermined area, display on the display a web page” may be omitted.
(Modification 11) The “area” is not limited to a country and may be information indicating an area larger than a country or information indicating an area (e.g., a city) smaller than a country.
(Modification 12) The home screen SC10 shown in FIG. 15 may not include the subscribe button 506. The consumable article setting screen SC24 shown in FIG. 16 may not include the second purchase button 562. In this modification, “display on the display a second predetermined screen” may be omitted.
(Modification 13) S112 in FIGS. 6 and S160 in FIG. 7 may be omitted. In this modification, when displaying the service information screen instead of the print preview screen, the device control app 44 may store print condition information set in the print preview screen. The device control app 44 then uses the stored print condition information when displaying the print preview screen. In this modification, “determine whether the processor is executing a predetermined process” and “display on the display a warning screen” may be omitted.
(Modification 14) The device control app 44 may execute S120 after making a determination of YES in S132 of FIG. 6. The device control app 44 may execute S170 after making a determination of YES in S192 of FIG. 7.
(Modification 15) When making a determination of YES in S132 of FIG. 6, the device control app 44 may not change the display information associated with the target notification information in the notification information table 52 from “displayed” to “not displayed yet”.
(Modification 16) In the above embodiment, the servers 200, 300, 400 are physical servers, however, they are not limited to physical servers and may be virtual servers or virtual machines on the cloud. That is, the vendor may use an environment provided by an external cloud computing service without preparing hardware for the servers 200, 300, 400. In this case, the vendor may prepare programs (i.e., software) for the servers 200, 300, 400 and introduce them into the above environment to implement the servers 200, 300, 400. In another modification, the servers 200, 300, 400 may be established on the internet by a business operator different from the vendor.
(Modification 17) In the embodiment, the processes in FIGS. 3 to 16 are executed by software (e.g., programs 40, 42, 44, 46), however, at least one of these processes may be executed by hardware such as a logic circuit, etc.

What is claimed is:

1. A non-transitory computer-readable recording medium storing a set of computer programs for a terminal device,
wherein the computer programs comprise a first computer program and a second computer program,
wherein the first computer program, when executed by a processor of the terminal device, causes the terminal device to:
display a first predetermined screen including service related information on a display of the terminal device, the service related information being related to a service for a printer communicable with the terminal device, the service being provided to a user of the printer via the internet; and
in a case where a first predetermined operation is received on the first predetermined screen, provide a display instruction to the second computer program, the display instruction being for displaying a service screen related to the service on the display,
wherein the second computer program, when executed by the processor, causes the terminal device to:
in a case where the display instruction is received from the first computer program, display the service screen on the display.

2. The non-transitory computer-readable recording medium as in claim 1, wherein the first computer program is a resident program and the second computer program is a non-resident program.

3. The non-transitory computer-readable recording medium as in claim 1, wherein in a case where a predetermined condition for a first printer is satisfied, the first predetermined screen including first device identification information for identifying the first printer is displayed on the display,
the display instruction includes the first device identification information, and
the service screen includes the first device identification information.

4. The non-transitory computer-readable recording medium as in claim 3, wherein the second computer program, when executed by the processor, further causes the terminal device to:
in a case where the display instruction is received from the first computer program under a state where second device identification information for identifying a second printer different from the first printer is in a memory of the terminal device as destination information indicating a printer to which a print instruction is to be sent, store the first device identification information in the memory as the destination information instead of the second device identification information.

5. The non-transitory computer-readable recording medium as in claim 3, wherein the second computer program, when executed by the processor, further causes the terminal device to:
in the case where the display instruction is received from the first computer program, determine whether a server supports the service for the first printer identified by the first device identification information included in the display instruction; and
in a case where it is determined that the server does not support the service, display on the display a web page represented by web page data received from a service server that provides the service, without displaying the service screen on the display,
wherein in a case where it is determined that the server supports the service, the service screen is displayed on the display.

6. The non-transitory computer-readable recording medium as in claim 1, wherein the second computer program, when executed by the processor, further causes the terminal device to:
in the case where the display instruction is received from the first computer program, determine whether a usage area where the terminal device is used is a predetermined area; and
in a case where it is determined that the usage area is not the predetermined area, display on the display a web page represented by web page data received from a service server that provides the service, without displaying the service screen on the display,
wherein in a case where it is determined that the usage area is the predetermined area, the service screen is displayed on the display.

7. The non-transitory computer-readable recording medium as in claim 1, wherein the second computer program, when executed by the processor, further causes the terminal device to:
display on the display a second predetermined screen including an object corresponding to the service screen,
wherein in a case where an operation is received on the object in the second predetermined screen, the service screen is displayed on the display without receiving the display instruction from the first computer program.

8. The non-transitory computer-readable recording medium as in claim 1, wherein the second computer program, when executed by the processor, further causes the terminal device to:
in the case where the display instruction is received from the first computer program, determine whether the processor is executing a predetermined process according to the second computer program; and
in a case where it is determined that the processor is executing the predetermined process, display on the display a warning screen indicating that the service screen is undisplayable, without displaying the service screen on the display,
wherein in a case where it is determined that the processor is not executing the predetermined process, the service screen is displayed on the display.

9. The non-transitory computer-readable recording medium as in claim 8, wherein the second computer program, when executed by the processor, further causes the terminal device to:
in a case where an operation for terminating display of the warning screen is received under a state where the warning screen is being displayed on the display, terminate the display of the warning screen without displaying the service screen on the display.

10. A non-transitory computer-readable recording medium storing a first computer program for a terminal device:
wherein the first computer program, when executed by a processor of the terminal device, causes the terminal device to:
display a first predetermined screen including service related information on a display of the terminal device, the service related information being related to a service for a printer communicable with the terminal device, the service being provided to a user of the printer via the internet; and
in a case where a first predetermined operation is received on the first predetermined screen, provide a display instruction to a second computer program for the terminal device, the display instruction being for displaying a service screen related to the service on the display.

11. The non-transitory computer-readable recording medium as in claim 10, wherein the first computer program is a resident program and the second computer program is a non-resident program.

12. The non-transitory computer-readable recording medium as in claim 10, wherein in a case where a predetermined condition for a first printer is satisfied, the first predetermined screen including first device identification information for identifying the first printer is displayed on the display,
the display instruction includes the first device identification information, and
the service screen includes the first device identification information.

13. A non-transitory computer-readable recording medium storing a second computer program for a terminal device:
wherein the second computer program, when executed by a processor of the terminal device, causes the terminal device to:
in a case where a display instruction to display a service screen related to a service on a display of the terminal device is received from a first computer program for the terminal device, display the service screen on the display, the service being for a printer communicable with the terminal device and provided to a user of the printer via the internet.

14. The non-transitory computer-readable recording medium as in claim 13, wherein the first computer program is a resident program and the second computer program is a non-resident program.

15. The non-transitory computer-readable recording medium as in claim 13, wherein the display instruction includes first device identification information for identifying a first printer,
wherein the second computer program, when executed by the processor, further causes the terminal device to:
in a case where the display instruction is received from the first computer program under a state where second device identification information for identifying a second printer different from the first printer is in a memory of the terminal device as destination information indicating a printer to which a print instruction is to be sent, store the first device identification information in the memory as the destination information instead of the second device identification information.

16. The non-transitory computer-readable recording medium as in claim 13, wherein the display instruction includes first device identification information for identifying a first printer,
wherein the second computer program, when executed by the processor, further causes the terminal device to:
in the case where the display instruction is received from the first computer program, determine whether a server supports the service for the first printer identified by the first device identification information included in the display instruction; and
in a case where it is determined that the server does not support the service, display on the display a web page represented by web page data received from a service server that provides the service, without displaying the service screen on the display,
wherein in a case where it is determined that the server supports the service, the service screen is displayed on the display.

17. The non-transitory computer-readable recording medium as in claim 13, wherein the second computer program, when executed by the processor, further causes the terminal device to:
in the case where the display instruction is received from the first computer program, determine whether a usage area where the terminal device is used is a predetermined area; and
in a case where it is determined that the usage area is not the predetermined area, display on the display a web page represented by web page data received from a service server that provides the service, without displaying the service screen on the display,
wherein in a case where it is determined that the usage area is the predetermined area, the service screen is displayed on the display.

18. The non-transitory computer-readable recording medium as in claim 13, wherein the second computer program, when executed by the processor, further causes the terminal device to:
display on the display a second predetermined screen including an object corresponding to the service screen,
wherein in a case where an operation is received on the object in the second predetermined screen, the service screen is displayed on the display without receiving the display instruction from the first computer program.

19. The non-transitory computer-readable recording medium as in claim 13, wherein the second computer program, when executed by the processor, further causes the terminal device to:
in the case where the display instruction is received from the first computer program, determine whether the processor is executing a predetermined process according to the second computer program; and
in a case where it is determined that the processor is executing the predetermined process, display on the display a warning screen indicating that the service screen is undisplayable, without displaying the service screen on the display,
wherein in a case where it is determined that the processor is not executing the predetermined process, the service screen is displayed on the display.
